(19) United States
(12) Patent Application Publication
(10) Pub. No.: US 2016/0319951 A1
(43) Pub. Date: Nov. 3, 2016

(54) VALVE

(71) Applicant: ROBERT BOSCH GMBH, Stuttgart (DE)

(72) Inventors: Markus Hartinger, Strasbourg (FR); Andreas lllmann, Weil Der Stadt (DE); Georg Reeb, Buehl Eisental (DE); Ralph Engelberg, Ditzingen (DE)

(73) Assignee: Robert Bosch GMBH, Stuttgart (DE)

(21) Appl. No.: 15/106,129

(22) PCT Filed: Dec. 18, 2014
(86) PCT No.: PCT/EP2014/078374

§ 371 Date: Jun. 17, 2016

(30) Foreign Application Priority Data
Dec. 19, 2013 (DE) 10 2013 226 566.2

(51) Int. Cl. F16K 31/04; F16K 31/06; F16K 1/12; F16K 3/02; F16K 31/00

(52) U.S. Cl. CPC F16K 31/047; F16K 3/0254; F16K 31/003; F16K 1/12; F16K 31/0644

(57) ABSTRACT

The invention relates to a valve for liquids (1) comprising valve means (40) and control means (10). According to the invention, the control means (10) comprise fail-safe means (15).

### BACKGROUND OF THE INVENTION

The invention relates to a fluid valve.

A fluid valve having a control means and a valve means is known.

### SUMMARY OF THE INVENTION

The fluid valve in accordance with the invention has control means that comprises fail-safe means and has the advantage that the control means assumes a predefined position in the event of a malfunction. A further advantage is that the calibration procedure, in other words the procedure of determining the position of the control means, is omitted after a malfunction. The fail-safe means expands the application of the fluid valve to include a safety function.

It is particularly advantageous that the valve means comprises at least one malfunction position and in the event of a malfunction, the valve means assumes the malfunction position by means of the fail-safe means. The fail-safe means provides that the valve means assumes a malfunction position in the event of a malfunction. The valve means is consequently located in a defined position in the event of a malfunction. This position can be defined with the construction of the valve. The valve consequently does not require complex electronics that avoid malfunctions or that supply the fluid valve with energy by means of a rechargeable battery by way of example when the energy supply fails.

Furthermore, it is to be regarded as being advantageous that the fail-safe means comprises a coil body that comprises a functional direction. When energized, the coil body of the fail-safe means generates a magnetic field that attracts or repels magnets or ferromagnetic elements. Coil bodies can be produced in a very simple and consequently cost-effective manner. The coil body renders it possible in a simple and cost-effective manner to adjust a control means and valve means to a malfunction position. It is not necessary to use complex mechanical constructions.

Furthermore, the fail-safe means advantageously comprises a releasing element. During the normal operation, the releasing element is locked in the normal operating position by means of the coil body. In the event of a malfunction, the releasing element is locked in a second position by a resilient element. The resilient element can be embodied in particular as a return spring. The releasing element represents a simple and cost-effective possibility of locking the fail-safe means in two positions: a normal operating position and a second position.

Furthermore, it is to be regarded as advantageous that the releasing element cooperates with the valve means and is in particular connected to said valve means and the valve means assumes the malfunction position if the releasing element is locked in the second position. The cooperation of the releasing element with the valve means renders possible a simplified fluid valve and thereby a fluid valve that can be easily adjusted. As a result of this cooperation, the valve means assumes a malfunction position if the releasing element is locked in the second position.

A particularly simple embodiment is consequently achieved by virtue of the fact that the coil body pre-stresses the resilient element in the normal operating position. The fact that the resilient element is pre-stressed by means of the coil body simplifies the construction of the fluid valve. Additional components or electrical circuits whose function would have been to pre-stress the spring are not required. Consequently, the complexity of the fluid valve is kept to a minimum.

It is particularly advantageous that the control means comprises a drive. The drive comprises a rotor. The releasing element is secured against rotation and connected parallel to the rotor, in particular in such a manner that said releasing element can be displaced along the longitudinal axis of the adjusting means. Furthermore, the releasing element is connected to the rotor in such a manner that said releasing element can be displaced along a rotor longitudinal axis. The releasing element comprises a positive-locking arrangement with respect to the rotor in the direction of rotation. The movement of the rotor can be transferred to the releasing element in a simple manner. Nevertheless, the releasing element can be displaced with respect to the rotor in the longitudinal direction.

It is advantageous that the releasing element comprises a threaded spindle and an anchor nut, wherein the threaded spindle cooperates with the anchor nut. The threaded spindle comprises in particular an outer thread and the anchor nut comprises an inner thread. The cooperation of the threaded spindle with the anchor nut renders possible a simple conversion of a rotational movement into a translational movement.

Furthermore, it is to be regarded as advantageous that the coil body when energized acts with a force upon the anchor nut of the releasing element and locks the releasing element in the normal operating position. The magnetic force by virtue of energizing the coil body represents a simple possibility for locking the releasing element in a position or for moving, in particular displacing or pressing the releasing element into the locked position.

The resilient element acts with a force on the anchor nut in a simple manner. The force that is applied by means of the resilient element counteracts the force that is generated by means of the energized coil body. Consequently, it is possible in dependence upon the strength of the forces to produce a locking arrangement by means of the force of the resilient element or the force of the energized coil body. Consequently, elements that increase the complexity are not required to implement the locking arrangement.

In a further advantageous further development, the wet region of the fluid valve is separated from the dry region by means of a pole pot. Additional lubrication is not required for the means of the releasing element as a result of arranging the releasing element within a pole pot. The releasing element can lubricate itself by means of the fluid that flows through the valve. Consequently, the durability of the fluid valve is improved.

It is advantageous that the valve means comprises at least one valve member and a valve housing. The releasing element cooperates with at least one valve member. Consequently, the valve member is controlled or regulated in a simple manner by the releasing means.

Furthermore, it is advantageous that the valve member is a sealing body that can be moved in a translational or rotational manner and opens a flow channel in dependence upon the position of said sealing body. The sealing effect can be improved in a simple manner by means of using a sealing body as a valve member.

It is particularly advantageous that the at least one valve member cooperates with at least one valve seat. A valve seat that is adjusted to the valve member renders possible a best possible sealing arrangement of the valve.

An embodiment that is particularly easy to produce is achieved by virtue of the fact that the valve member is embodied as one part with the threaded spindle. Assembly steps by means of which the valve member is connected to the threaded spindle are consequently omitted.

### BRIEF DESCRIPTION OF THE DRAWINGS

Exemplary embodiments of the invention are illustrated in the drawings hereinunder and explained in detail in the following description. In the figures:

FIG. 1 illustrates a fluid valve in accordance with the invention comprising a valve means and a control means having a fail-safe means,

FIG. 2 illustrates the fluid valve in the normal operating position,

FIG. 3 illustrates the fluid valve in the malfunction position,

FIG. 4 illustrates an exemplary embodiment of a valve means,

FIG. 5 illustrates a further exemplary embodiment of a valve means and

FIG. 6 illustrates a further exemplary embodiment of a valve means.

### DETAILED DESCRIPTION

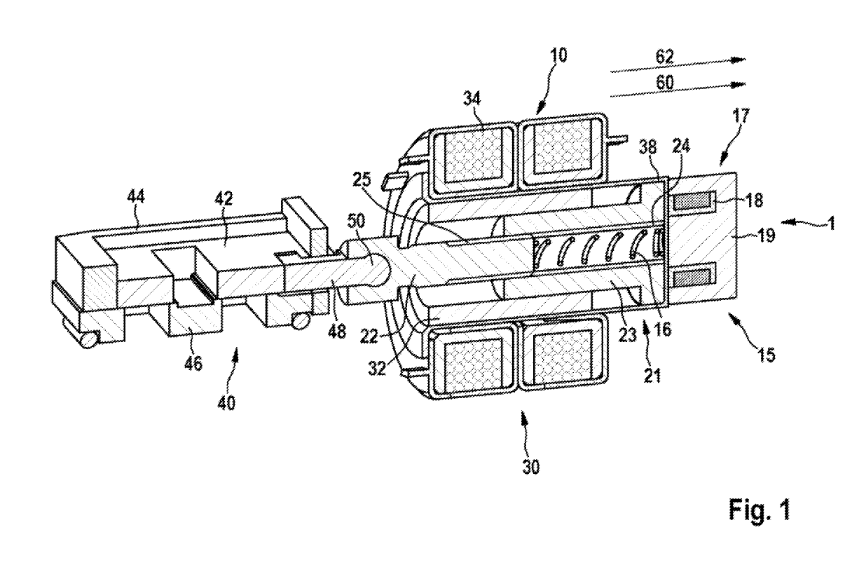

FIG. 1 illustrates a fluid valve 1 in accordance with the invention. The fluid valve 1 comprises a control means 10 and a valve means 40. The control means 10 comprises a fail-safe means 15 and a drive 30. The fail-safe means 15 comprises a coil body 17 having a coil that comprises at least one winding 18 and an iron core 19. The winding of the coil 18 is wound around the iron core 19. The ends of the winding of the coil 18 are connected to the electronics system that controls the drive 30 or the energy source that supplies the drive with energy. The coil body 17 is attached to an end of the control means 10. The coil body 17 is attached to the end of the control means 10 that is remote from the valve means 40. The coil body 17 comprises a functional direction 60.

Furthermore, the fail-safe means 15 comprises a releasing element 21. The releasing means 21 is arranged in the control means 10 in such a manner that said releasing means can move. Furthermore, the releasing element 21 is arranged in such a manner that it can move with respect to the coil body 17. In the fluid valve 1 in accordance with the invention in accordance with FIG. 1, the control means 10 comprises a control functional direction 62. The control functional direction 62 of the control means 10 is essentially identical to the functional direction 60 of the coil body 17. The control functional direction 62 extends parallel to or on the longitudinal axis of the control means 10. The movement of the releasing element 21 occurs in or opposite to the functional direction 60 of the coil body 17 or the control functional direction 62.

The releasing element 21 comprises a threaded spindle 22 and an anchor nut 23. The threaded spindle 23 cooperates with the coil body 17. The anchor nut 23 is arranged in such a manner that it can move in and opposite to the control functional direction 62. The anchor nut 23 is in particular produced at least in part from a metal or includes metal or magnetic elements. Furthermore, the fail-safe means 15 comprises a resilient element 16. The resilient element 16 counteracts the functional direction 60 of the coil body 17. The resilient element 16 is embodied in FIG. 1 in an exemplary manner as a spring, in particular a return spring 16. Further examples for a resilient element 16 in accordance with the invention are coil springs, helical springs, leg springs, zigzag springs, torsion springs, leaf springs, cup springs or conical springs. The resilient element 16 can also be formed from a resilient synthetic material or further resilient materials. The resilient element 16 behaves in a resilient resetting manner. The resilient element 16 comprises two ends. The resilient element 16 is connected with its first end to the coil body 17. A washer (not illustrated) is advantageously located between the resilient element 16 and the coil body 17. The second end of the resilient element 16 is connected to the releasing element 21. A washer (not illustrated) is also advantageously located between the releasing element 21 and the resilient element 16. In accordance with FIG. 1, the second end of the resilient element 16 is connected to the threaded spindle 22. The resilient element 16 is embodied in FIG. 1 as a compression spring 16. The compression spring 16 presses the releasing element 21 away from the coil body 17. The resilient element 16, in particular the return spring, preferably the compression spring 16, presses the releasing element 21 away from the coil body 17. However, it is also possible to design the resilient element 16 based on tensile force. Consequently, the releasing element 21 would not be pulled away from the coil body 17 by way of a compressive force according to the compression spring 16 in FIG. 1 but rather by way of a tensile force.

Furthermore, the anchor nut 23 comprises an inner thread 24. The outer thread 25 of the threaded spindle 22 engages in the inner thread 24 of the anchor nut 23. The inner thread 24 and the outer thread 25 cooperate. The rotation of the anchor nut 23 relative to the threaded spindle 22 displaces the threaded spindle 22 along or parallel to the longitudinal axis of the control means 10, in particular in and opposite to the control functional direction 62. The threaded spindle 22 screws into the anchor nut 23 or out of said anchor nut in dependence upon the direction of rotation. The anchor nut 23 and the threaded spindle 22 convert a rotational rotating movement into a translational movement. The threaded spindle 22 is embodied essentially from a threaded rod, in other words a cylindrical round bar having an outer thread, in particular a trapezoidal or flat thread.

The control means 10 comprises a drive 30. The drive 30 comprises a stator 34 and a rotor 32. The stator 34 comprises at least one coil that comprises at least one further winding. The stator 34 can be embodied from an arbitrary number of coils having an arbitrary number of windings. In the case of an EC drive, the stator comprises in particular 3 phases that in each case comprise at least one coil having at least one winding. The coils generate a magnetic field owing to a current flow. The magnetic field in turn leads to the rotor 32 rotating. The windings of the coils are energized by a current according to the position of the rotor 32. By way of example, an electronic circuit (not illustrated) controls the current flow for this purpose. The control by way of the electronic circuit can be performed in dependence upon the number of coils, in particular one, two or three coils and the type of circuit (star connection or delta connection) by way of example by way of a full bridge, an inverter connection or an EC motor control.

The rotor 32 is embodied from a ferromagnetic material, a magnetic material or a material that is drawn from a magnetic pole of an exterior magnetic field. It is also possible that the rotor 32 is embodied from a synthetic material and ferromagnetic or magnetic elements, in particular magnets are injection molded into said synthetic material. The magnetic elements or elements that cooperate with a magnetic field are consequently encased in an injection molded synthetic material. The synthetic material and the magnets form the rotor 32.

The rotor 32 cannot be moved in the longitudinal direction of the control means 10. A positive locking arrangement prevents the rotor 32 moving along the longitudinal axis of the control means 10 or in or opposite to the control functional direction 62.

In accordance with FIG. 1, the rotor 32 of the drive 30 corresponds to the rotor 32 of the releasing element 21. In accordance with a further exemplary embodiment, the rotor 32 of the releasing element 21 can be connected by way of a belt or a transmission to a further rotor of the drive 30.

The releasing element 21 cooperates with the rotor 32. The releasing element 21 is connected to the rotor 32 so as to be able to move in parallel or along the longitudinal axis of the control means 10. Consequently, the releasing element 21 is arranged in such a manner that it can be displaced in or opposite to the control functional direction 62 with respect to the rotor 32. A retaining element (not illustrated), in particular stops, prevents the releasing element 21 from detaching from the rotor 32. The releasing element 21 and the rotor 32 are connected to one another in a rotationally secure manner. A rotation of the rotor 32 is transferred to the releasing element 21 and leads to a rotation of the releasing element 21. The anchor nut 23 of the releasing element 21 cooperates with a rotor 32. By way of example, the anchor nut 23 comprises a groove along the longitudinal axis, said groove extending in or opposite to the direction of rotation. The rotor 32 comprises an element that engages in the groove and forms a positive locking arrangement with the rotor 32. Elements of this type are formed by way of example by means of a screw head, a phase, a soldering point or welding point. The releasing element 21 and the rotor 32 comprise a positive locking arrangement in the direction of rotation. In the case of a rotation of the rotor 32, the positive locking arrangement leads to a rotation of the releasing element 21, preferably the anchor nut 23, and conversely.

Furthermore, the control means 10 comprises a pole pot 38. The pole pot 38 comprises a peripheral surface, a pole pot base and a pole pot ring. The peripheral surface and the pole pot base form an interior space. The pole pot ring is used by way of example so as to fasten the pole pot to the control means 10. The releasing element 21, the resilient element 16 and the rotor 32 are located in the interior space of the pole pot 38. The pole pot 38 prevents fluids or gases being exchanged between the interior space and the region outside the pole pot 38. The coil carrier 17 is arranged outside the pole pot 38 on the pole pot base. The pole pot base is arranged between the anchor nut 23 and the coil body 17. Furthermore, a thrust washer or a ball bearing is arranged between the pole pot base and the anchor nut 23. The ball bearing and/or the thrust washer render it possible for the anchor nut 23 to rotate with respect to the pole pot base. The stator 34 of the drive 30 is arranged on the peripheral surface of the pole pot. The pole pot 38 is advantageously produced from a material that does not comprise magnetic characteristics, in particular synthetic material or aluminum. However, the pole pot 38 can also be embodied from a ferromagnetic material or a material that conducts the magnetic field and can conduct the magnetic flux of the coil body 17 or the drive 30.

The valve means 40 comprises at least one valve member 42 and a valve housing (not illustrated). The valve housing comprises fluid lines by way of which the fluids can be conveyed into the valve housing and can be conveyed out of the valve housing. Furthermore, the valve housing comprises guiding elements 44 that guide the valve member 42. The guiding elements 44 form a stop for the valve member 42. Furthermore, the valve means 40 comprises a valve seat 46. The valve seat 46 cooperates with the valve member 42. A channel of an arbitrary size is opened in dependence upon the position of the valve member 42 with respect to the valve seat 46. The size of the channel is dependent upon the position or the adjustment position of the valve member 42 with respect to the valve seat 46. The valve member 42 and the valve seat 46 render it possible to open the channel entirely and consequently render possible a maximum through flow of fluid. However, said valve member and valve seat also render it possible to completely close the channel and thereby not allow a flow of fluid through the fluid valve 1. Furthermore, said valve member and valve seat render possible any extent of opening between entirely open and completely closed.

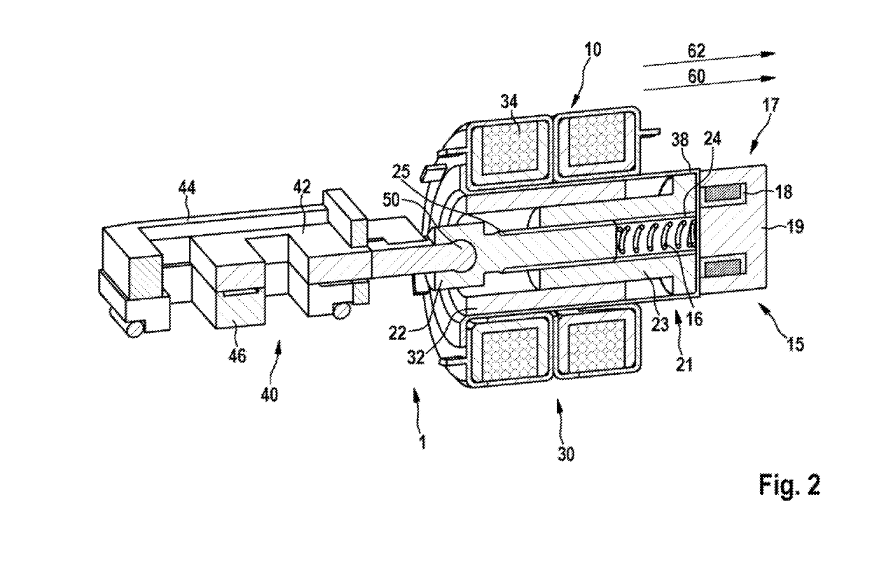

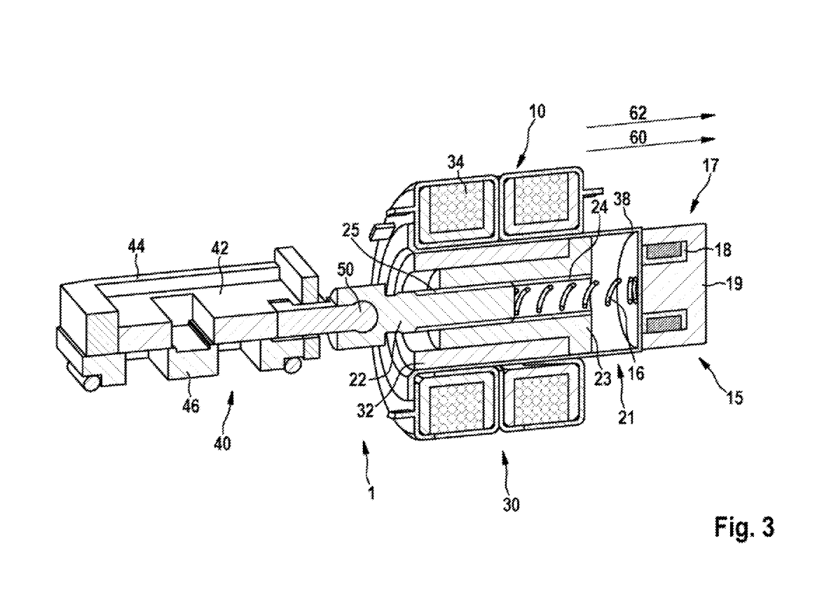

The control means 10 controls the valve means 40. For this purpose, the valve means 40 comprises a guiding arbor 48. The guiding arbor 48 connects the valve member 42 to the releasing element 21 of the control means 10. The guiding arbor 48 is connected to the threaded spindle 22 of the releasing element 21. In particular, it is also possible that the threaded spindle 22 is directly connected to the valve member 42. Or the threaded spindle 22, the guiding arbor 48 and the valve member 42 are embodied as one part. An articulated joint 50 is arranged between the guiding arbor 48 and the threaded spindle 22. The articulated joint 50 renders possible an angle between the longitudinal axis of the control means 10 and the longitudinal axis of the valve means 40. Furthermore, by way of example the valve member 42 can rotate by means of the articulated joint while the threaded spindle 22 is not rotated. The articulated joint 50 is embodied as a ball joint in an exemplary manner. The further FIGS. 2 and 3 have the identical reference numerals as FIG. 1 and illustrate the fluid valve 1 in further operating positions. The function of the fluid valve 1 is explained hereinunder with reference to the FIGS. 1 to 3.

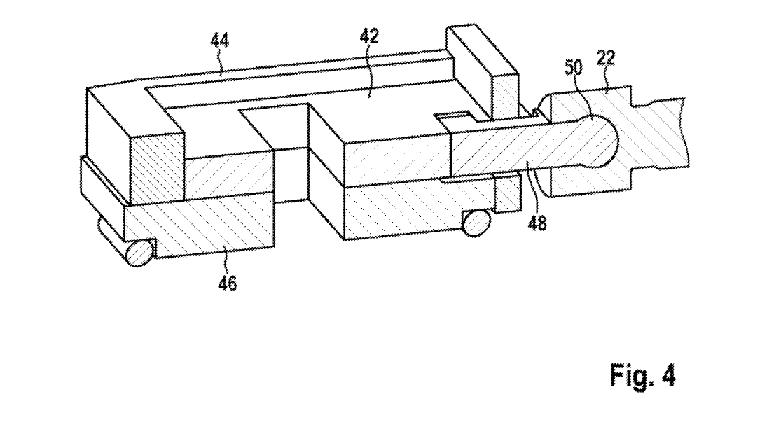

FIG. 1 illustrates the fluid valve 1 in the normal operating position. The coil body 19 is energized in an electrical manner and generates a magnetic field. The magnetic field generates a force in the functional direction 60 of the coil body 17. The force attracts the anchor nut 23. The anchor nut 23 is consequently moved parallel to the longitudinal axis of the control means 10 or in a translational manner in the functional direction 60. The anchor nut 23 moves until a stop. The stop forms by way of example the pole pot base, a thrust washer, a ball bearing or the coil carrier 23. In accordance with FIG. 1, the anchor nut 23 is displaced until it makes physical contact with the pole pot base. The threaded spindle 22 and anchor nut 23 are moved out to their maximum possible extent in FIG. 1. Said threaded spindle and anchor nut comprise their maximum length. The resilient element 16, in particular the return spring 16, is pre-stressed. The valve member 42 lies against the stop of the valve means 40. The valve member 42 covers the openings of the valve seat 46. The channel is consequently closed in the valve housing. Fluids cannot flow through the valve means 40. It is possible by means of adjusting the valve member 42 and the valve seat 46 that the channel is entirely opened (cf. FIG. 4) in this operating state. It is also possible that only one part of the channel is opened. The extent to which the channel is opened or closed is dependent upon the design of the valve member 42 and the valve seat 46 or on the design of the valve member 42 with respect to the valve seat 46. If the drive 30 is activated, the rotor 32 starts to rotate. The rotational movement is transferred from the rotor 32 to the anchor nut 23 by means of a positive locking arrangement between the rotor 32 and the anchor nut 23. The anchor nut 23 rotates with the rotor 32. The anchor nut 23 and the threaded spindle 22 convert the rotational movement into a translational movement of the threaded spindle 22. The translational movement of the threaded spindle 22 occurs in or opposite to the control functional direction 62. Whether the translational movement occurs in or opposite to the control functional direction 62 is dependent upon the direction of rotation of the rotor 32 or the drive 30 and the type of thread. The threaded spindle 22 is rotated into the anchor nut 23 by means of rotating said anchor nut, in particular screwed in or rotated out, in particular screwed out. The valve member 42 is moved by means of screwing the threaded spindle 22 into the anchor nut 23.

FIG. 2 illustrates the fluid valve 1 in the normal operating position. As is illustrated in FIG. 1, the coil body 17 is energized in an electrical manner. The coil body 17 attracts the releasing element 21. In contrast to FIG. 1, the rotor 32 is rotated. The rotation of the rotor 32 leads to the threaded spindle 22 being screwed into the anchor nut 23. The rotatory rotational movement of the rotor 32 was converted into a translational movement of the threaded spindle 22. The threaded spindle 22 is displaced in a translational manner in the control functional direction 62. In addition, the valve member 42 is displaced into the control functional direction 62. The valve member 42 and the valve seat 46 open at least one channel. In FIG. 2, two channels are opened in an exemplary manner or a flow can be allowed through said channels. The channel renders possible a flow of liquid or a flow of gas through the valve means 40. It is also possible that the channel is blocked in this operating state. This is dependent upon the design of the valve member 42 with respect to the valve seat 46.

In FIG. 3, a malfunction has occurred. Malfunctions occur by way of example owing to electronic malfunctions, current supply failures, ruptured cables, ruptured lines, problems at further components of the motor vehicle or software problems. If a malfunction of the electronics is identified or is broadcast by way of communications channels of the electronics system, the supply of current to the coil body 17 is thus interrupted. If there is a failure of the current supply, the coil body 17 is also thus not supplied with current. A magnetic field is not generated owing to the interruption of the current supply to the coil body 17. Consequently, the releasing element 21 is not influenced in the functional direction 60 by a force. The releasing element 21 is moved from the resilient element 16 in a direction opposite to the functional direction 60. The resilient element 16 presses the releasing element 21 in the control functional direction 62. The releasing element 21 is locked in a second position by the resilient element 16. The releasing element 21 is connected to the valve means 40. If the releasing element 21 is located in the second position, the valve means 40 is thus located in the malfunction position. The releasing element 21 moves the valve member 42 as far as the stop of the valve means 40. The channel is closed in the valve means 40. The flow of fluid through the valve means 40 is blocked.

If the malfunction is repaired, initially the starting position in accordance with FIG. 1 is reinstated. For this purpose, the rotor 32 is rotated by means of the drive 30. The rotation causes a translational movement of the threaded spindle 22 with respect to the anchor nut 23. The valve member 42 lies against the stop of the valve means 40. The rotation of the rotor 32 is intended to unscrew the threaded spindle 22 from the anchor nut 23. Consequently, the anchor nut 23 is moved in the control functional direction 62. The anchor nut 23 is moved in the control functional direction 62 owing to the threaded spindle 22 being unscrewed with respect to the anchor nut 23. The rotational movement of the rotor 32 is consequently converted into a translational movement of the anchor nut 23. The anchor nut 23 is moved until the anchor nut 23 makes physical contact with the pole pot base or the coil body 17. However, the movement can be locked prior to the anchor nut 23 making physical contact with the pole pot base or the coil body 17. If the translational movement of the anchor nut 23 occurs, the coil body 17 can be energized. The coil body 17 attracts the releasing element 21 by means of the magnetic field of said coil body. A minimal supply of current to the coil body 17 is necessary owing to the small spacing between releasing element 21 and coil body 17. The fluid valve 1 is in the normal state in accordance with FIG. 1. The fluid valve 1 can be calibrated by means of the above described process in the event of a malfunction.

FIG. 4 illustrates a valve means 40. FIG. 4 comprises the identical reference numerals as FIGS. 1 to 3. The form of the valve seat 46 is changed with respect to the FIGS. 1 to 3. The valve member 42 and the valve seat 46 open a channel in the event of a malfunction. Consequently, it is possible in the malfunction state for a flow to occur through the valve means 40, in particular a flow of fluid. The valve member 42 is connected to a guiding arbor 48. The guiding arbor 48 is connected to the threaded spindle 22 of the control means 10 by way of the articulated joint 50. The guiding arbor 48 and the threaded spindle 22 can also be embodied as one part. The guiding arbor 48 comprises means that allow a translational movement but do not allow rotational movement.

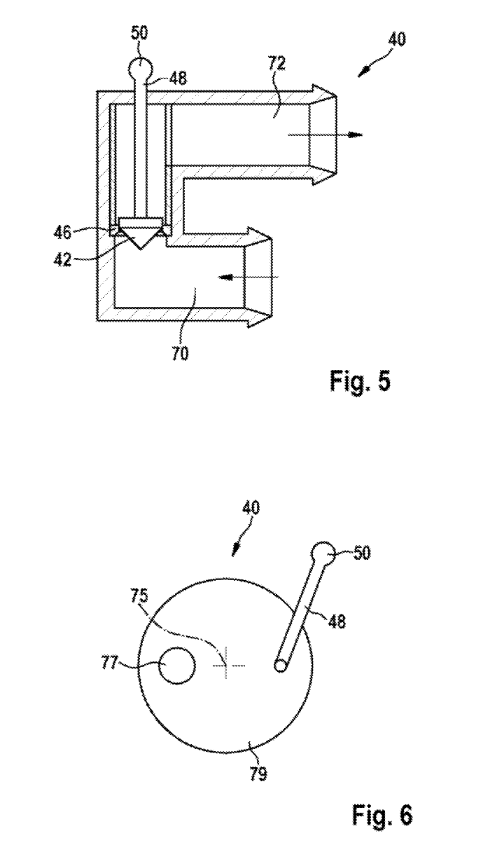

FIG. 5 illustrates a further valve means 40 in accordance with the invention. The valve means 40 comprises a valve housing. The valve housing comprises an inlet line 70 and an outlet line 72. The inlet line 70 and the outlet line 72 are connected to one another by way of a channel. A valve seat 46 is arranged in the channel. The valve seat 46 cooperates with the valve member 42. The channel is opened or blocked in dependence upon the position of the valve member 42 with respect to the valve seat 46 for transporting gas and/or liquid. In FIG. 4, the channel is closed. Consequently, fluid cannot flow from the inlet line 70 to the outlet line 72 and conversely. The valve member 42 is connected to the guiding arbor 48. The guiding arbor 48 is connected by way of the articulated joint 50 to the threaded spindle 22 of the control means 10. The guiding arbor 48 and the threaded spindle 22 can also be embodied as one part. The guiding arbor 48 comprises means that allow a translational movement but do not allow rotational movement.

FIG. 6 illustrates a further exemplary embodiment for a valve means 40. The valve means 40 comprises a valve member 42 that is embodied as a round disk, hereinunder described as valve member disk 79. The valve member disk 79 is mounted in such a manner that it can rotate about its own axis 75. The valve disk 79 comprises at least one opening 77. In dependence upon the rotational position of the valve disk 79 with respect to a valve seat (obscured in the drawing by the valve disk), a channel is formed by means of the at least one opening 77 and a further opening in the valve seat. The channel renders possible a flow of liquid or a flow of gas through the valve means 40. A guiding arbor 48 is attached to the valve disk 79. The guiding arbor 48 comprises an articulated joint 50. The articulated joint 50 connects the guiding arbor 48 to the threaded spindle 22.

In accordance with a further exemplary embodiment, the coil carrier 17 can also be connected to the releasing element 21. The coil carrier 17 then acts upon a part of the control means 10, by way of example the pole pot base.

The fluid valve 1 in accordance with the invention can in particular be used in vehicles or heating systems.

1. A fluid valve (1) comprising a valve means (40) and a control means (10), characterized in that the control means (10) comprises fail-safe means (15).

2. The fluid valve (1) as claimed in claim 1, characterized in that the valve means (40) comprises at least one malfunction position and in the event of a malfunction the valve means (40) assumes the malfunction position by means of the fail-safe means (15).

3. The fluid valve (1) as claimed in claim 1, characterized in that the fail-safe means (15) comprises a coil body (17).

4. The fluid valve (1) as claimed in claim 3, characterized in that the fail-safe means (15) furthermore comprises a releasing element (21) that is locked during normal operation in a normal operating position by the coil body (17), and in the event of a malfunction is locked in a second position by a resilient element.

5. The fluid valve (1) as claimed in claim 1, characterized in that the releasing element (21) cooperates with the valve means (40), and the valve means (40) assumes the malfunction position if the releasing element (21) is locked in the second position.

6. The fluid valve (1) as claimed in claim 4, characterized in that the coil body (17) pre-stresses the resilient element (16) in a normal operating position.

7. The fluid valve (1) as claimed in claim 4, characterized in that the control means (10) comprises a drive (30), wherein the drive (30) comprises a rotor (32), and the releasing element (21) is secured against rotation and is connected to the rotor (32) in such a manner that said releasing element can be displaced along the rotor longitudinal axis.

8. The fluid valve (1) as claimed in claim 4, characterized in that the releasing element (21) comprises a threaded spindle (22) and an anchor nut (23), wherein the threaded spindle (22) cooperates with the anchor nut (23).

9. The fluid valve (1) as claimed in claim 8, characterized in that the coil body (17) when energized acts with a force upon the anchor nut (23) of the releasing element (21) and locks the releasing element (21) in the normal operating position of the releasing element.

10. The fluid valve (1) as claimed in claim 9, characterized in that the resilient element (16) acts upon the anchor nut (23) with a force, wherein the force by the resilient element (16) counteracts the force that is generated by means of the energized coil body (17).

11. The fluid valve (1) as claimed in claim 4, characterized in that the releasing element (21) is arranged within a pole pot (38).

12. The fluid valve (1) as claimed in claim 11, characterized in that the valve means (40) comprises at least one valve member (42) and the releasing element (21) cooperates with the at least one valve member (42).

13. The fluid valve (1) as claimed in claim 12, characterized in that the valve member (42) is a sealing body that can move and opens a through flow channel in dependence upon the position of said sealing body.

14. The fluid valve (1) as claimed in claim 12, characterized in that the at least one valve member (42) cooperates with at least one valve seat (46).

15. The fluid valve (1) as claimed in claim 12, characterized in that the valve member (42) is embodied as one part with the threaded spindle (22).

16. The fluid valve (1) as claimed in claim 3, characterized in that the fail-safe means (15) furthermore comprises a releasing element (21) that is locked during normal operation in a normal operating position by the coil body (17), and in the event of a malfunction is locked in a second position by a return spring (16).

17. The fluid valve (1) as claimed in claim 1, characterized in that the releasing element (21) is connected to said valve means, and the valve means (40) assumes the malfunction position if the releasing element (21) is locked in the second position.

18. The fluid valve (1) as claimed in claim 4, characterized in that the releasing element (21) comprises a threaded spindle (22) and an anchor nut (23), wherein the threaded spindle (22) comprises an outer thread and the anchor nut (23) comprises an inner thread cooperating with the outer thread.
